(19) United States
(12) Patent Application Publication
(10) Pub. No.: US 2006/0268820 A1
(43) Pub. Date: Nov. 30, 2006

(54) IP header compression with IPv6 mobile node

(76) Inventors: Heikki Mahkonen, Helsinki (FI); Arto Mahkonen, Helsinki (FI); Eva Gustafsson, Stockholm (SE); Tony Larsson, Stockholm (SE); Conny Larsson, Taby (SE); Ulf Bjorklund, Johanneshov (SE)

Correspondence Address: ERICSSON INC., 6300 LEGACY DRIVE, M/S EVR C11, PLANO, TX, 75024, US

(21) Appl. No.: 11/134,205

(22) Filed: May 19, 2005

(51) Int. Cl. H04L 12/56

(52) U.S. Cl. 370/349; 370/392

(57) ABSTRACT

An IPv6 mobile node is described herein that compresses a packet such that the compressed packet which includes an outer IP header, a compressed inner IP header and data can be sent within a bi-directional tunnel via one or more IP networks to a remote device (e.g., home agent, correspondent node, another mobile node). The IPv6 mobile node can also compress the outer IP header in the packet in addition to compressing the inner IP header if it is located in a wireless access network. The remote device can compress the packet in the same manner and send it to the IPv6 mobile node.

### BACKGROUND OF THE INVENTION

1. Field of the Invention

The present invention relates to an IPv6 mobile node that can compress a packet so it can be efficiently sent within a bi-directional tunnel (e.g., IPv4/UDP bi-directional tunnel) from one access network through one or more IP networks (e.g., Internet) to another access network which contains a remote device (e.g., home agent, correspondent node, another mobile node).

2. Description of Related Art

In the wireless communications field, a protocol known as Mobile IPv6 is used today which allows IPv6 MNs to remain reachable while moving around in IPv6 access networks connected to an IP network like the Internet. Without this mobility support, packets destined to an IPv6 MN would not be able to reach it while the IPv6 MN is located away from its home link. The Mobile IPv6 protocol is described in detail in the following documents:
S. Deering et al., “Internet Protocol, Version 6 (IPv6) Specification”, RFC 2460, December 1998.
D. Johnson et al., “Mobility Support in IPv6”, RFC 3775, June 2004.
   The contents of these documents are incorporated by reference herein.

In addition to the IPv6 access networks, there are also IPv4 access networks in use today that are connected to the Internet. The IPv4 access networks are designed and made in accordance with another protocol known as Mobile IPv4. The Mobile IPv4 protocol enables an IPv4 MN to be reached while it is located in an IPv4 access network that is not its home link. The Mobile IPv4 protocol is described in detail in the following document:
C. Perkins, “IP Mobility Support”, RFC 2002, October 1996.
   The contents of this document are incorporated by reference herein.

The Mobile IPv4 and Mobile IPv6 protocols are designed for IPv4-only access networks and IPv6-only access networks, respectively. As such, the Mobile IPv6 protocol does not provide backwards compatibility to IPv4 networks. This means that Mobile IPv6 protocol is not capable of mobility management across IPv4 (public and private) access networks. However, mobility management of IPv6 MNs located in IPv4 (public and private) access networks is particularly important. Because, IPv6 MNs (e.g., IPv6 mobile computers) which are located in IPv4 access networks are likely to account for a portion of the population of the devices that are going to be connected to the Internet. This mobility management problem has been solved. Two different solutions to this problem were discussed in a related PCT Patent Application No. ______ entitled “Mobile IPv6 Route Optimization in Different Address Spaces” (Attorney Docket No. P20155). The contents of this document are incorporated by reference herein.

Unfortunately, these solutions utilize a lot of bandwidth because more overhead is needed since an additional IP header must be added to the packet so the IPv6 MN can be reached regardless of the type of access network they happen to be located in at that time. FIGS. 1 and 2 (PRIOR ART) are provided to illustrate the header information that needs to be added to the packet so the IPv6 MN can move to an access network (e.g., IPv4 access network, IPv6 access network) and still communicate with a device (e.g., home agent (HA), correspondent node (CN), MN2) located in another access network.

Referring to FIG. 1 (PRIOR ART), there is illustrated a diagram used to show the additional overhead in a packet 110 and 128 that is needed so an IPv6 MN 102 can communicate with a remote CN 104a (or another MN 104b) when the MN 102 is located in an IPv6 WLAN/LAN access network 106 and when the MN 102 is located in an IPv6 3G access network 108. When, the MN 102 is located in the IPv6 WLAN/LAN access network 106, the packet 110a/110b is sent in a bi-directional tunnel 113 between the MN 102 and the HA 116 or the CN 104a (or MN 104b) via an IPv6 router 112, one or more IP networks 114 (e.g., Internet 114), a home agent (HA) 116 and a home link (HL) 118. Packet 110a is used when the HL 118 is an IPv6 HL 118 and the MN 102 is sending IPv6 traffic to the HA 116 or the MN 102 is sending/receiving IPv6 traffic to/from the remote CN 104a (or another MN 104b) and the traffic between them is not route optimized. This packet 110a includes an outer IP header (“IPv6”), an inner IP header (“IPv6/UDP/RTP”) and data. And, packet 10b is used when the HL 118 is an IPv4 HL 118 and the MN 102 is sending/receiving IPv4 traffic from the IPv6 access network 106. In this case, all the IPv4 traffic must be tunneled inside a bi-directional IPv6 tunnel 113 between the peer nodes 102, 104a, 104b and 116. This packet 110b includes an outer IP header (“IPv6”), an inner IP header (“IPv4/UDP/RTP”) and data. The inner IP headers “IPv6/UDP/RTP” and “IPv4/UDP/RTP” are the headers introduced by the application sending the data between the peer nodes 102, 104a, 104b and 116. And, the outer header in packet 110a and 110b is the additional overhead that is needed so packet 110a and 110b can be sent in the bi-directional tunnel 113. The MN 102 also includes a routing table 122 when it is located in the IPv6 WLAN/LAN access network 106. An exemplary routing table 122 is provided below:

MN's Routing Table 122:

| | | | Compression |
|---|---|---|---|
| Destination: | Next Hop: | Intf: | Context: |
| “HA IPv6” | “HA IPv6” | IPv6 tunnelintf0 | No |
| | | | compression |
| “HA IPv4” | “HA IPv6” | IPv6 tunnelintf0 | No |
| | | | compression |
| “CN IPv4” | “CN IPv6” | IPv6 tunnelintf1 | No |
| | | | compression |
| “MN2 IPv4” | “MN2 IPv6” | IPv6 tunnelintf2 | No |
| | | | compression |
| “HA IPv6” | “default IPv6 | intf0 | No |
| | router” | | compression |
| “CN IPv6” | “default IPv6 | intf0 | No |
| | router” | | compression |
| “MN2 IPv6” | “default IPv6 | Intf0 | No |
| | router” | | compression |

When, the MN 102 is located in the IPv6 3G access network 108, a packet 124 is sent between the MN 102 and a RNC 126. This packet 124 includes a compressed IP header (“cmp”) and “IPv6/UDP/RTP” or “IPv4/UDP/RTP” and data. A packet 128a and 128b is also shown which is sent in a bi-directional tunnel 127 between the MN 102 and the HA 116 or the remote CN 104a (or another MN 104b) via a gateway GPRS service node (GGSN) 130, the IP network(s) 114, the HA 116 and the HL 118. The first/last “hop” of this tunnel 127 is sent inside a tunnel between the MN 102 and the radio network controller (RNC) 126. In this additional tunnel between the MN 102 and the RNC 126, the IP header compression is used to compress the outer IPv6 header. Packet 128a is used when the MN 102 is sending IPv6 traffic to the HA 116 or if the MN 102 is sending/receiving IPv6 traffic to/from the remote CN 104a (or another MN 104b) and the traffic between them is not route optimized. This packet 128a includes an outer IP header (“IPv6”), an inner IP header (“IPv6/UDP/RTP”) and data. And, packet 128b is used when the HL 118 is an IPv4 HL 118 and the MN 102 is sending/receiving IPv4 traffic from the IPv6 access network 108. In this case, all the IPv4 traffic must be tunneled inside a bi-directional IPv6 tunnel 127 between the peer nodes 102, 104a, 104b and 116. This packet 128b includes an outer IP header (“IPv6”), an inner IP header (“IPv4/UDP/RTP”) and data. Each of the outer IP headers “IPv6” in packet 128a and 128b is the decompressed “cmp” associated with packet 124. And, the inner IP header “IPv6/UDP/RTP” and “IPv4/UDP/RTP” are the headers introduced by the application sending the data between the peer nodes 102, 104a, 104b and 116. And, the outer IPv6 header in packet 128a and 128b is the additional overhead that is needed so packet 128a and 128b can be sent in the bi-directional tunnel 127. The MN 102 also includes a routing table 132 when it is located in the IPv6 3G access network 108. An exemplary routing table 132 is provided below:

MN's Routing Table 132:

| | | | Compression |
|---|---|---|---|
| Destination: | Next Hop: | Intf: | Context: |
| “HA IPv6” | “HA IPv6” | IPv6 tunnelintf0 | No |
| | | | compression |
| “HA IPv4” | “HA IPv6” | IPv6 tunnelintf0 | No |
| | | | compression |
| “CN IPv4” | “CN IPv6” | IPv6 tunnelintf1 | No |
| | | | compression |
| “MN2 IPv4” | “MN2 IPv6” | IPv6 tunnelintf2 | No |
| | | | compression |
| “HA IPv6” | “default IPv6 | intf0 | MN1 <-> RNC |
| | router” | | |
| “CN IPv6” | “default IPv6 | intf0 | MN1 <-> RNC |
| | router” | | |
| “MN2 IPv6” | “default IPv6 | Intf0 | MN1 <-> RNC |
| | router” | | |

A drawback of this scenario is that packets 110a, 110b, 128a and 128b have both an outer IP header and an inner IP header which adds a lot of overhead to the traffic in the access networks 106, 108 and 118 and the Internet 114. It would be desirable if some of the overhead in the packets 110a, 110b, 128a and 128b could be reduced which in turn would save valuable bandwidth in the access networks 106, 108 and 118 and the Internet 114. This need is addressed by the present invention.

Referring to FIG. 2 (PRIOR ART), there is illustrated a diagram used to show the additional overhead in a packet 210 and 228 that is needed so an IPv6 MN 202 can communicate with the HA 116 or a remote CN 204a (or another MN 204b) when the MN 202 is located in an IPv4 WLAN/LAN access network 206 and when the MN 202 is located in an IPv4 3G access network 208. When, the MN 202 is located in the IPv4 WLAN/LAN access network 206, the packet 210a or 210b is sent in a bi-directional tunnel 213 between the MN 202 and the HA 216 or the CN 204a (or MN 204b) via an IPv4 router 212, one or more IP networks 214 (e.g., Internet 214′), a HA 216 and a HL 218. Packet 210a is used when the HL 218 is an IPv6 HL 218 and the MN 202 is sending IPv6 traffic to the HA 216 or if the MN 202 is sending/receiving IPv6 traffic to/from the remote CN 204a (or another MN 204b) and the traffic between them is not route optimized. This packet 210a includes an outer IP header (“IPv4/UDP”), an inner IP header (“IPv6/UDP/RTP”) and data. And, packet 210b is used when the HL 218 is an IPv4 HL 218 and the MN 202 is sending/receiving IPv4 traffic from its IPv4 HoA. This packet 210b includes an outer IP header (“IPv4/UDP”), an inner IP header (“IPv4/UDP/RTP”) and data. The inner IP headers “IPv6/UDP/RTP” and “IPv4/UDP/RTP” are the headers introduced by the application sending the data between the peer nodes 202, 204a, 204b and 216. And, the outer IPv4 and UDP header in packet 210a and 210b introduces the additional overhead that is needed so packet 210a and 210b can be sent in the bi-directional “IPv4/UDP” tunnel 213. The MN 202 also includes a routing table 222 when it is located in the IPv4 WLAN/LAN access network 206. An exemplary routing table 222 is provided below:

MN's Routing Table 222:

| | | | Compression |
|---|---|---|---|
| Destination: | Next Hop: | Intf: | Context: |
| “HA IPv6” | “HA IPv4” | UDP tunnelintf0 | No |
| | | | compression |
| “HA IPv4” | “HA IPv4” | UDP tunnelintf0 | No |
| | | | compression |
| “CN IPv6” | “CN IPv4” | UDP tunnelintf1 | No |
| | | | compression |
| “CN IPv4” | “CN IPv4” | UDP tunnelintf1 | No |
| | | | compression |
| “MN2 IPv6” | “MN2 IPv4” | UDP tunnelintf2 | No |
| | | | compression |
| “MN2 IPv4” | “MN2 IPv4” | UDP tunnelintf2 | No |
| | | | compression |
| “HA IPv4” | “default IPv4 | intf0 | No |
| | router” | | compression |
| “CN IPv4” | “default IPv4 | intf0 | No |
| | router” | | compression |
| “MN2 IPv4” | “default IPv4 | Intf0 | No |
| | router” | | compression |

When, the MN 202 is located in the IPv4 3G access network 208, a packet 224 is sent between the MN 202 and a RNC 226. This packet 224 includes a compressed IPv4 header and UDP header (“cmp”) and “IPv6/UDP/RTP” or “IPv4/UDP/RTP” and data. A packet 228a and 228b is also shown that is sent in a bi-directional tunnel 227 between the MN 202 and the HA 216 or the remote CN 204a (or another MN 204b) via a GGSN 230, one or more IP networks 214 (e.g., Internet 214), the HA 216 and the HL 218. The first/last “hop” of this tunnel 227 is sent inside a tunnel between the MN 202 and the RNC 226. In this additional tunnel between the MN 202 and the RNC 226, the IP header compression is used to compress the outer IPv4/UDP header. Packet 228a is used when the HL 218 is an IPv6 HL 218 and the MN 202 is sending IPv6 traffic to the HA 216 or if the MN 202 is sending/receiving IPv6 traffic to/from the remote CN 204a (or another MN 204b) and the traffic between them is not route optimized. This packet 228a includes an outer IP header (“IPv4/UDP”), an inner IP header (“IPv6/UDP/RTP”) and data. And, packet 228b is used when the HL 218 is an IPv4 HL 218 and the MN 202 is sending/receiving IPv4 traffic from its IPv4 HoA. This packet 228b includes an outer IP header (“IPv4/UDP”), an inner IP header (“IPv4/UDP/RTP”) and data. Each of the outer IP headers “IPv4/UDP” in packet 228a and 228b is the decompressed “cmp” associated with packet 224. And, the inner IP header “IPv6/UDP/RTP” and “IPv4/UDP/RTP” are the headers introduced by the application sending the data between the peer nodes 202, 204a, 204b and 216. And, the outer IPv4 and UDP headers in packet 228a and 228b introduces the additional overhead that is needed so packet 228a and 228b can be sent in the bi-directional tunnel 227. The MN 202 also includes a routing table 232 when it is located in the IPv4 3G access network 208. An exemplary routing table 232 is provided below:

MN's Routing Table 232:

| | | | Compression |
|---|---|---|---|
| Destination: | Next Hop: | Intf: | Context: |
| “HA IPv6” | “HA IPv4” | UDP tunnelintf0 | No |
| | | | compression |
| “HA IPv4” | “HA IPv4” | UDP tunnelintf0 | No |
| | | | compression |
| “CN IPv6” | “CN IPv4” | UDP tunnelintf1 | No |
| | | | compression |
| “CN IPv4” | “CN IPv4” | UDP tunnelintf1 | No |
| | | | compression |
| “MN2 IPv6” | “MN2 IPv4” | UDP tunnelintf2 | No |
| | | | compression |
| “MN2 IPv4” | “MN2 IPv4” | UDP tunnelintf2 | No |
| | | | compression |
| “HA IPv4” | “default IPv4 | intf0 | MN1 <-> RNC |
| | router” | | |
| “CN IPv4” | “default IPv4 | intf0 | MN1 <-> RNC |
| | router” | | |
| “MN2 IPv4” | “default IPv4 | Intf0 | MN1 <-> RNC |
| | router” | | |

A drawback of this scenario is that packets 210a, 210b, 228a and 228b have both an outer IP header and an inner IP header which adds a lot of overhead to the traffic in the access networks 206, 208 and 218 and the Internet 214. It would be desirable if some of the overhead in the packets 210a, 210b, 228a and 228b could be reduced which in turn would save valuable bandwidth in the access networks 206, 208 and 218 and the Internet 214. This need is addressed by the present invention.

### BRIEF DESCRIPTION OF THE INVENTION

The present invention includes a Mobile IPv6 mobile node, correspondent node and home agent. Each of these nodes can compress and uncompress the inner IP headers of the tunneled packets they send and receive. As described herein, while a MN is attached to an access network away from home link it creates a bi-directional tunnel (home tunnel) between itself and the HA which is situated at the MNs home link. This tunnel is setup from the MN at the foreign network and it goes through the access router and the IP networks between the foreign link and the home link and to the HA in the home link. The home tunnel is used for all not route optimized traffic sent and received by the MN. When this invention is used together with the invention described in PCT Patent Application No. ______ entitled “Mobile IPv6 Route Optimization in Different Address Spaces” (Attorney Docket No. P20155) which enables the MN to optimize the routing between other MNs and CNs it has in some traffic cases bi-directional tunnels between itself and other Mobile IPV6 nodes. This tunnel is setup from the MN in the foreign access network and goes through the access router and the IP networks between the MNs access network and the other MNs or CNs access network and through the access routers in the other end and all the way to the other MN or the CN. Both of the tunnels described above can either be setup from an IPv4 or an IPv6 access network. When these tunnels are used to send/receive traffic, the inner IP headers of these packets can be compressed by the sender in accordance with the present invention. If the access network the MN is attached to supports IP header compression, then the outer header can also be compressed when these packets are sent over the aerial interface.

An uncompressed tunneled packet contains an outer IP header which is either an IPv6 header or an IPv4/UDP header depending on the traffic case. Inside this tunnel header (outer IP header) the packet has the inner IP headers and the data of the packet. When this packet is compressed in accordance with the present invention, the outer header of the packet is left untouched and the inner headers are compressed. However, if the access network (3G) supports header compression, then the outer headers can also be compressed while the packet is transmitted over the aerial interface. This compression is uncompressed by some node (in 3G RNC) in the network before it reaches the IP networks behind the access network.

### BRIEF DESCRIPTION OF THE DRAWINGS

A more complete understanding of the present invention may be had by reference to the following detailed description when taken in conjunction with the accompanying drawings wherein:

FIG. 1 (PRIOR ART) is a diagram that is used to show the additional overhead in a packet that is needed so an IPv6 MN can communicate with a remote CN (another MN) when the MN is located in an IPv6 WLAN/LAN access network and when the MN is located in an IPv6 3G access network;

FIG. 2 (PRIOR ART) is a diagram that is used to show the additional overhead in a packet that is needed so an IPv6 MN can communicate with a remote CN (another MN) when the MN is located in an IPv4 WLAN/LAN access network and when the MN is located in an IPv4 3G access network;

FIG. 3 is a diagram that is used to show how a packet can be compressed so an IPv6 MN can efficiently communicate with a remote device (CN, HA, another MN) when the MN is located in an IPv6 WLAN/LAN access network and when the MN is located in an IPv6 3G access network;

FIG. 4 is a diagram that is used to show how a packet can be compressed so an IPv6 MN can efficiently communicate with a remote device (CN, HA, another MN) when the MN is located in an IPv4 WLAN/LAN access network and when the MN is located in an IPv4 3G access network;

FIG. 5 is a diagram used to help describe the four different scenarios that can be used by an IPv6 MN (or remote device) to compress packets in accordance with the present invention;

FIG. 6 is a flowchart that illustrates the basic steps on how the IPv6 MN compresses a packet in accordance with the present invention.

### DETAILED DESCRIPTION OF THE DRAWINGS

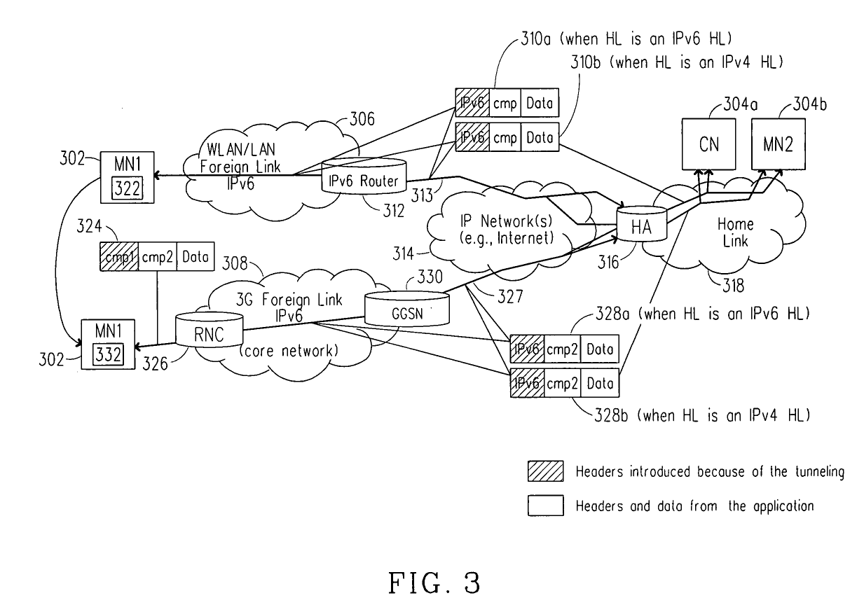

Referring to FIGS. 3-6, there are disclosed different scenarios in which an IPv6 MN (or another node) can compress a packet in accordance with the present invention. To aid in the discussion of the present invention several different exemplary networks are used which include well known components like an IPv4 access network, IPv6 access network, IPv4/IPv6 access network, HL, HA, IP network, Internet, IPv4 router, IPv6 router etc . . . For clarity, the description provided herein omits certain details about these well known components that are not necessary to understand the present invention.

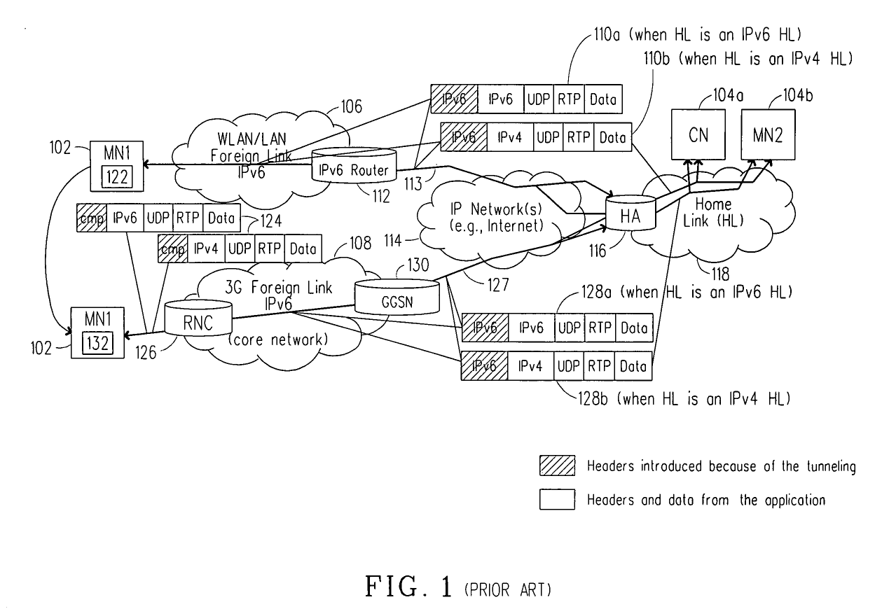

Referring to FIG. 3, there is illustrated a diagram used to show how a packet 310 and 328 can be compressed so an IPv6 MN 302 can efficiently communicate with a remote device (CN 304a, HA 316 or another MN 304b) when the MN 302 is located in an IPv6 WLAN/LAN access network 306 and when the MN 302 is located in an IPv6 3G access network 308. When, the MN 302 is located in the IPv6 WLAN/LAN access network 306, the compressed packet 310a and 310b is sent in a bi-directional tunnel 313 between the MN 302 and the HA 316 or the CN 304a (or MN 304b) via an IPv6 router 312, one or more IP networks 314 (e.g., Internet 314), a HA 316 and a HL 318. The compressed packet 310a is used when the HL 318 is an IPv6 HL 318 and the MN 302 is sending IPv6 traffic to the HA 316 or if the MN 302 is sending/receiving IPv6 traffic to/from the remote CN 304a (or another MN 304b) and the traffic between them is not route optimized. This packet 310a includes an outer IP header (“IPv6”), a compressed inner IP header (“cmp”) and data. The compressed inner IP header (“cmp”) was formed from IPv6/UDP/RTP which are the headers introduced by the application sending data. And, the outer IPv6 header is the additional overhead that is needed so packet 310a can be sent in the bi-directional tunnel 313 to the HA 316 or the CN 304a (or MN 304b) (compare to FIG. 1).

In contrast, the compressed packet 310b is used when the HL 318 is an IPv4 HL 318 and the MN 302 is sending/receiving IPv4 traffic from the IPv6 access network 306. In this case, all the IPv4 traffic must be tunneled inside a bi-directional IPv6 tunnel 313 between the peer nodes 302, 304a, 304b and 316. The compressed packet 310b includes an outer IP header (“IPv6”), a compressed inner IP header (“cmp”) and data. The compressed inner IP header (“cmp”) was formed from IPv4/UDP/RTP which are the headers introduced by the application sending data. And, the outer IPv6 header is the additional overhead that is needed so packet 310b can be sent in the bi-directional tunnel 313 to the HA or the CN 304a (or MN 304b)(compare to FIG. 1).

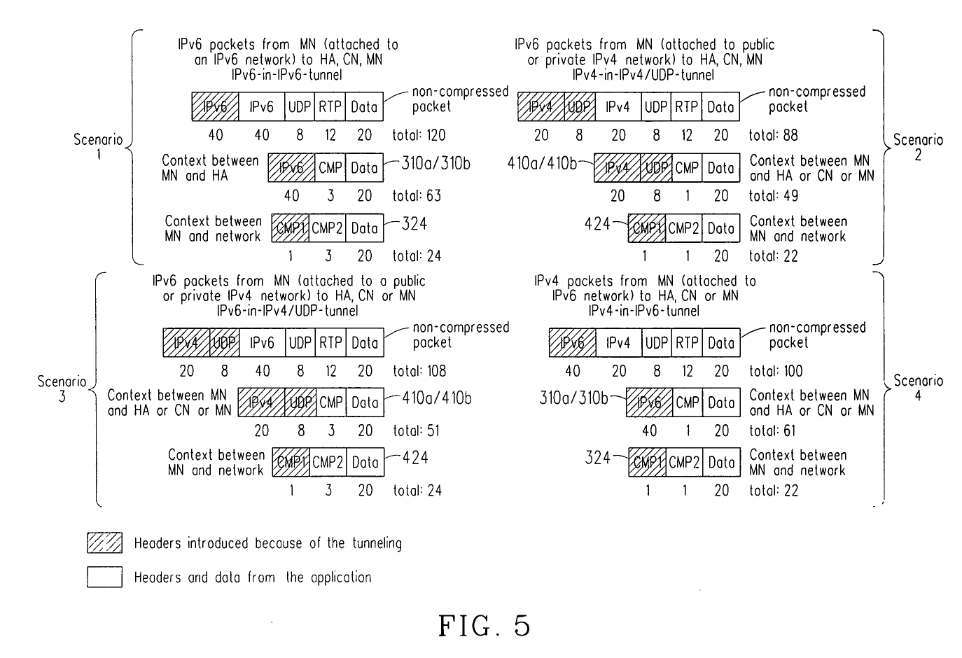

The MN 302 also uses a routing table 322 when it is located in the IPv6 WLAN/LAN access network 306. The routing table 322 indicates the tunnels 313 which can be used between nodes 302 and 304a/304b/316. The exemplary routing table 322 provided below indicates two different types of scenarios 1 and 4 which can be used to compress packets 310a and 310b. A more detailed discussion about how packets 310a and 310b can be compressed in accordance with scenarios 1 and 4 is provided below with respect to FIG. 5.

MN's Routing Table 322:

| Destination: | Next Hop: | Intf: | Compression Context: |
|---|---|---|---|
| “HA IPv6” | “HA IPv6” | IPv6 | MN1 <-> HA (scenario 1) |
| | | tunnelintf0 | |
| “HA IPv4” | “HA IPv6” | IPv6 | MN1 <-> HA (scenario 4) |
| | | tunnelintf0 | |
| “CN IPv4” | “CN IPv6” | IPv6 | MN1 <-> CN (scenario 4) |
| | | tunnelintf1 | |
| “MN2 IPv4” | “MN2 IPv6” | IPv6 | MN1 <-> MN2(scenario 4) |
| | | tunnelintf2 | |
| “HA IPv6” | “default IPv6 | intf0 | No additional compression |
| | router” | | |
| “CN IPv6” | “default IPv6 | intf0 | No additional compression |
| | router” | | |
| “MN2 IPv6” | “default IPv6 | intf0 | No additional compression |
| | router” | | |

When, the MN 302 is located in the IPv6 3G wireless access network 308, a packet 324 is sent between the MN 302 and a RNC 326. This packet 324 includes two compressed IP headers (“cmp1” and “cmp2”) and data. The compressed packet 328a and 328b is also shown which is sent in a bi-directional tunnel 327 between the MN 302 and the HA 316 or the remote CN 304a (or another MN 304b) via the GGSN 330, one or more IP networks 314 (e.g., Internet 314), the HA 316 and the HL 318. The first/last “hop” of this tunnel 327 is sent inside a tunnel between the MN 302 and the radio network controller (RNC) 326. In this additional tunnel between the MN 302 and the RNC 326, the IP header compression is used to compress the outer IPv6 header. Packet 328a is used when the HL 318 is an IPv6 HL 318 and the MN 302 is sending IPv6 traffic to the HA 316 or if the MN 302 is sending/receiving IPv6 traffic to/from the remote CN 304a (or another MN 304b) and the traffic between them is not route optimized. This packet 328a includes an outer IP header (“IPv6”), a compressed inner IP header (“cmp2”) and data. The outer IP header (“IPv6”) is the decompressed “cmp1” associated with packet 324. And, the compressed inner IP header (“cmp2”) was formed from IPv6/UDP/RTP which are the headers introduced by the application sending data. And, the outer IPv6 header is the additional overhead that is needed so packet 328a can be sent in the bi-directional tunnel 327 to the HA 316 or the CN 304a (or MN 304b)(compare to FIG. 1).

In contrast, the compressed packet 328b is used when the HL 318 is an IPv4 HL 318 and the MN 302 is sending/receiving IPv4 traffic from the IPv6 access network 308. In this case, all the IPv4 traffic must be tunneled inside a bi-directional IPv6 tunnel 327 between the peer nodes 302, 304a, 304b and 316. The compressed packet 328b includes an outer IP header (“IPv6”), a compressed inner IP header (“cmp2”) and data. The outer IP header (“IPv6”) is the decompressed “cmp1” associated with packet 324. And, the compressed inner IP header (“cmp2”) was formed from IPv4/UDP/RTP which are the headers introduced by the application sending data. And, the outer IPv6 header is the additional overhead that is needed so packet 328b can be sent in the bi-directional tunnel 327 to the CN 304a (or MN 304b)(compare to FIG. 1).

The MN 302 also uses a routing table 332 when it is located in the IPv6 3G wireless access network 308. The routing table 332 indicates the tunnels 327 which can be used between nodes 302 and 304a/304b/316. The exemplary routing table 332 provided below indicates two different types of scenarios 1 and 4 which can be used to compress packets 328a and 328b. A more detailed discussion about how packets 328a and 328b can be compressed in accordance with scenarios 1 and 4 is provided below with respect to FIG. 5.

MN's Routing Table 332:

| Destination: | Next Hop: | Intf: | Compression Context: |
|---|---|---|---|
| “HA IPv6” | “HA IPv6” | IPv6 | MN1 <-> HA (scenario 1) |
| | | tunnelintf0 | |
| “HA IPv4” | “HA IPv6” | IPv6 | MN1 <-> HA (scenario 4)_{—} |
| | | tunnelintf0 | |
| “CN IPv4” | “CN IPv6” | IPv6 | MN1 <-> CN (scenario 4)_{—} |
| | | tunnelintf1 | |
| “MN2 IPv4” | “MN2 IPv6” | IPv6 | MN1 <-> MN2 (scenario 4) |
| | | tunnelintf2 | |
| “HA IPv6” | “default | intf0 | MN1 <-> RNC (scenario |
| | IPv6 | | 1/4) |
| | router” | | |
| “CN IPv6” | “default | intf0 | MN1 <-> RNC (scenario 4) |
| | IPv6 | | |
| | router” | | |
| “MN2 IPv6” | “default | intf0 | MN1 <-> RNC (scenario 4) |
| | IPv6 | | |
| | router” | | |

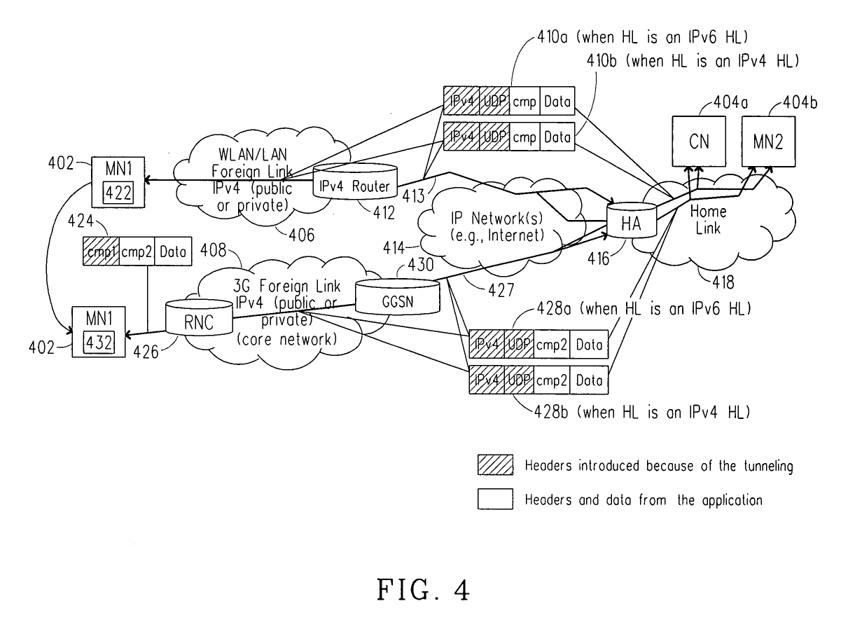

Referring to FIG. 4, there is illustrated a diagram used to show how a packet 410 and 428 can be compressed so an IPv6 MN 402 can efficiently communicate with a remote device (CN 404a, HA 416 or another MN 404b) when the MN 402 is located in an IPv4 WLAN/LAN access network 406 and when the MN 402 is located in an IPv4 3G access network 408. When, the MN 402 is located in the IPv4 WLAN/LAN access network 406, the compressed packet 410a and 410b is sent in a bi-directional tunnel 413 between the MN 402 and the HA 416 or the CN 404a (or MN 404b) via an IPv6 router 412, one or more IP networks 414 (e.g., Internet 414), a HA 416 and a HL 418. The compressed packet 410a is used when the HL 418 is an IPv6 HL 418 and the MN 402 is sending IPv6 traffic to the HA 416 or if the MN 402 is sending/receiving IPv6 traffic to/from the remote CN 404a (or another MN 404b) and the traffic between them is not route optimized. This packet 410a includes an outer IP header (“IPv4/UDP”), a compressed inner IP header (“cmp”) and data. The compressed inner IP header (“cmp”) was formed from IPv6/UDP/RTP which are the headers introduced by the application sending data. And, the outer IPv4 and UDP header is the additional overhead that is needed so packet 410a can be sent in the bi-directional tunnel 413 to the CN 404a (or MN 404b) (compare to FIG. 1).

In contrast, the compressed packet 410b is used when the HL 418 is an IPv4 HL 418 and the MN 402 is sending/receiving IPv4 traffic from its IPv4 HoA. The compressed packet 410b includes an outer IP header (“IPv4/UDP”), a compressed inner IP header (“cmp”) and data. The compressed inner IP header (“cmp”) was formed from IPv4/UDP/RTP which are the headers introduced by the application sending data. And, the outer IPv4 and UDP headers introduce the additional overhead that is needed so the packet 410b can be sent in the bi-directional tunnel 413 to the CN 404a (or MN 404b)(compare to FIG. 1).

The MN 402 also uses a routing table 422 when it is located in the IPv4 WLAN/LAN access network 406. The routing table 422 indicates the tunnels 413 which can be used between nodes 402 and 404a/404b/416. The exemplary routing table 422 provided below indicates two different types of scenarios 2 and 3 which can be used to compress packets 410a and 410b. A more detailed discussion about how packets 410a and 410b can be compressed in accordance with scenarios 2 and 3 is provided below with respect to FIG. 5.

MN's Routing Table 422:

| Destination: | Next Hop: | Intf: | Compression Context: |
|---|---|---|---|
| “HA IPv6” | “HA IPv4” | UDP tunnelintf0 | MN1 <-> HA |
| | | | (scenario 3) |
| “HA IPv4” | “HA IPv4” | UDP tunnelintf0 | MN1 <-> HA |
| | | | (scenario 2)_{—} |
| “CN IPv6” | “CN IPv4” | UDP tunnelintf1 | MN1 <-> CN |
| | | | (scenario 3)_{—} |
| “CN IPv4” | “CN IPv4” | UDP tunnelintf1 | MN1 <-> CN |
| | | | (scenario 2)_{—} |
| “MN2 IPv6 | “MN2 IPv4” | UDP tunnelintf2 | MN1 <-> MN2 |
| | | | (scenario 3)_{—} |
| “MN2 IPV4” | “MN2 IPv4” | UDP tunnelintf2 | MN1 <-> MN2 |
| | | | (scenario 2)_{—} |
| “HA IPv4” | “default | intf0 | No additional |
| | IPv4 | | compression |
| | router” | | |
| “CN IPv4” | “default | intf0 | No additional |
| | IPv4 | | compression |
| | router” | | |
| “MN2 IPv4 | “default | Intf0 | No additional |
| | IPv4 router | | compression |

When, the MN 402 is located in the IPv4 3G wireless access network 408, a packet 424 is sent between the MN 402 and a RNC 426. This packet 424 includes two compressed IP headers (“cmp1” and “cmp2”) and data. The compressed packet 428a and 428b is also shown that is sent in a bi-directional tunnel 427 between the MN 402 and the HA 416 or the remote CN 404a (or another MN 404b) via a GGSN 430, one or more IP networks 414 (e.g., Internet 414), the HA 416 and the HL 418. The first/last “hop” of this tunnel 427 is sent inside a tunnel between the MN 402 and the RNC 426. In this additional tunnel between the MN 402 and the RNC 426, the IP header compression is used to compress the outer IPv6 header. Packet 428a is used when the HL 418 is an IPv6 HL 418 and the MN 402 is sending IPv6 traffic to the HA 416 or if the MN 402 is sending/receiving IPv6 traffic to/from the remote CN 304a (or another MN 304b) and the traffic between them is not route optimized. This packet 428a includes an outer IP header (“IPv4/UDP”), a compressed inner IP header (“cmp2”) and data. The outer IP header (“IPv4/UDP”) is the decompressed “cmp1” associated with packet 424. And, the compressed inner IP header (“cmp2”) was formed from IPv6/UDP/RTP which are the headers introduced by the application sending data. And, the outer IPv4 and UDP header introduce the additional overhead that is needed so packet 428a can be sent in the bi-directional tunnel 427 to the HA 416 or the CN 404a (or MN 404b)(compare to FIG. 1).

In contrast, the compressed packet 428b is used when the HL 418 is an IPv4 HL 418 and the MN is sending/receiving IPv4 traffic from its IPv4 HoA. The compressed packet 428b includes an outer IP header (“IPv4/UDP”), a compressed inner IP header (“cmp2”) and data. The outer IP header (“IPv4/UDP”) is the decompressed “cmp1” associated with packet 424. And, the compressed inner IP header (“cmp2”) was formed from IPv4/UDP/RTP which are the headers introduced by the application sending data. And, the outer IPv4 and UDP header introduce the additional overhead that is needed so packet 428b can be sent in the bi-directional tunnel 427 to the CN 404a (or MN 404b)(compare to FIG. 1).

The MN 402 also uses a routing table 432 when it is located in the IPv4 3G wireless access network 408. The routing table 432 indicates the tunnels 427 which can be used between nodes 402 and 404a/404b/416. The exemplary routing table 432 provided below indicates two different types of scenarios 2 and 3 which can be used to compress packets 428a and 428b. A more detailed discussion about how packets 428a and 428b can be compressed in accordance with scenarios 2 and 3 is provided below with respect to FIG. 5.

MN's Routing Table 432:

| Destination: | Next Hop: | Intf: | Compression Context: |
|---|---|---|---|
| “HA IPv6” | “HA IPv4” | UDP tunnelintf0 | MN1 <-> HA |
| | | | (scenario 3) |
| “HA IPv4” | “HA IPv4” | UDP tunnelintf0 | MN1 <-> HA |
| | | | (scenario 2)_{—} |
| “CN IPv6” | “CN IPv4” | UDP tunnelintf1 | MN1 <-> CN |
| | | | (scenario 3)_{—} |
| “CN IPv4” | “CN IPv4” | UDP tunnelintf1 | MN1 <-> CN |
| | | | (scenario 2)_{—} |
| “MN2 IPv6 | “MN2 IPv4” | UDP tunnelintf2 | MN1 <-> MN2 |
| | | | (scenario 3)_{—} |
| “MN2 IPV4” | “MN2 IPv4” | UDP tunnelintf2 | MN1 <-> MN2 |
| | | | (scenario 2)_{—} |
| “HA IPv4” | “default | intf0 | MN1 <-> RNC |
| | IPv4 | | (scenario 2/3)_{—} |
| | router” | | |
| “CN IPv4” | “default | intf0 | MN1 <-> RNC |
| | IPv4 | | (scenario 2/3)_{—} |
| | router” | | |
| “MN2 IPv4” | “default | Inft0 | MN1 <-> RNC |
| | IPv4 router | | (scenario 2/3)_{—} |

Referring to FIG. 5, there are shown diagrams used to describe the four different scenarios that can be used to compress packets 310a, 310b, 328a, 328b, 410a, 410b, 428a and 428b in accordance with the present invention. As described above, scenarios 1 and 4 are associated with packets 310a, 310b, 328a and 328b (see FIG. 3). And, scenarios 2 and 3 are associated with packets 410a, 410b, 428a and 428b (see FIG. 4). The MN 302 and 402 typically sends or receives an audio stream with a data packet in the range of 10 to 40 bytes. For example in scenario 3, assume that 20 bytes of audio data is sent in a packet and that the application uses IPv6 and that the MN 302 is currently in an IPv4 access network 306 (see FIG. 3). The application data is encapsulated within RTP header 12 byte, UDP header 8 bytes and IPv6 header 40 bytes. The packet is 80 bytes before the tunnel headers are added. The packet is tunneled inside an IPv4 header 20 bytes and UDP header 8 bytes. The UDP header is needed for NAT traversal (see aforementioned PCT patent application Ser. No. ______ (Attorney Docket No. P20155). The total size of the packet is then 108 bytes. When, for instance, Robust Header Compression (ROHC) is used to compress the inner header of the packet one can compress the IPv6, UDP and RTP headers down to 3 bytes. So the packet 310a or 310b that is sent has 51 bytes. As can be seen, the IP header compression saves 53% in the general compression case where the compression is used when the MN 302 is located in a WLAN/LAN access network 306 (for example).

If the MN 302 is located in the 3G wireless access network 308, then the MN 302 can further compress the packet 324 before transmitting it over the aerial interface to a RNC 326 (for example). In this case, the outer IP header “IPv4/UDP” of the tunneled packet 324 can be compressed normally to 1 byte headers shown as “cmp1” so the packet tunneled inside IPv4 tunnel will be transmitted as 24 bytes of data. In this example, the IP header compression can save aerial bandwidth by 78%. The compression in other traffic cases and the compression saved by using the present invention is illustrated in FIG. 5 and in TABLE 1.

TABLE 1

| | | | Compression | | Compression | |
|---|---|---|---|---|---|---|
| Traffic case | | | context | | context | |
| between MN1 | | | between MN1 | | between the | |
| and the HA, | Original | Tunneled | and the HA, | | MN and wireless | |
| MN2 or CN. | packet | packet | MN2 or CN. | | network. | |
| — | Bytes | Bytes | Bytes | Save % | Bytes | Save % |
| IPv6-in-IPv6 | 80 | 120 | 63 | 48 | 24 | 80 |
| IPv6-in- | 80 | 108 | 51 | 53 | 24 | 78 |
| IPv4/UDP | | | | | | |
| IPv4-in-IPv6 | 60 | 100 | 61 | 39 | 22 | 78 |
| IPv4-in- | 60 | 88 | 49 | 44 | 22 | 75 |
| IPv4/UDP | | | | | | |

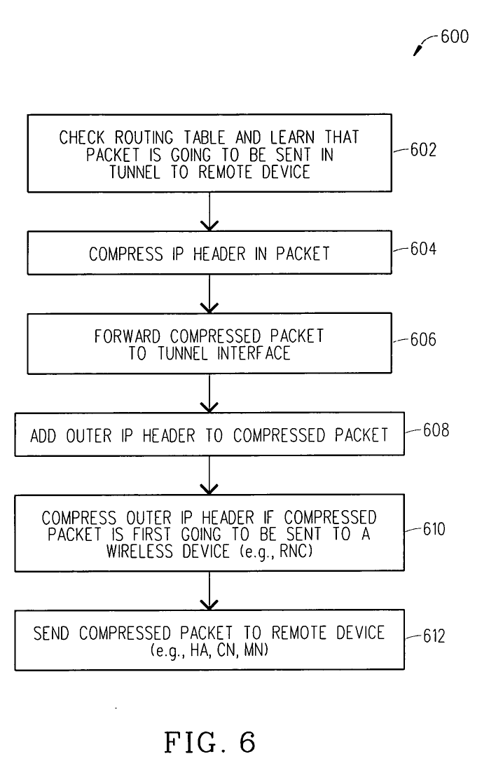

Referring to FIG. 6, there is a flowchart illustrating the basic steps of a method 600 on how the MN 302 and 402 can compress a packet in accordance with the present invention. Before, the MN 302 and 402 sends a packet of data it checks it's routing table 322, 332, 422, 432 (step 602). When, the MN 302 and 402 learns from the routing table 322, 332, 422 and 432 that the packet will be sent through a bi-directional tunnel 313, 327, 413 and 427 to the remote device 316, 304a, 304b, 416, 404a and 404b it checks the IP header compression context and compresses the inner IP header in the packet (steps 602 and 604). After the uncompressed headers are replaced by the compression header, the packet is sent to the MN's tunnel interface (step 606). The tunnel interface adds the outer IP header to the packet (step 608). Before, the compressed packet 310a, 310b, 410a and 410b is sent out to the physical interface, the compression context between the MN 302 and 402 and the access network is checked. And, if the access network is a wireless access network 308 and 408, then the MN 302 and 402 also compresses the outer IP header (step 610). This assumes, the MN 302 and 402 has a compression context for the outer IP header in the compressed packet 328a, 328b, 428a and 428b. Then, the compressed packet 328a, 328b, 428a and 428b is sent to the remote device 316, 304a, 304b, 416, 404a and 404b (step 612). At the other end, the remote device 316, 304a, 304b, 416, 404a and 404b decompresses the compressed IP headers in the received compressed packet 310a, 310b, 328a, 328b, 410a, 410b, 428a, 428b.

In addition, when the remote device 316, 304a, 304b, 416, 404a and 404b sends a tunneled packet to the MN 302 and 402 it compresses the inner IP header of the packet according to its compression context it has between itself and the MN 302 and 402. Moreover, the remote device 316, 304a, 304b, 416, 404a and 404b can compress the outer IP header if the packet is going to be transmitted over an aerial interface to MN 302 and 402.

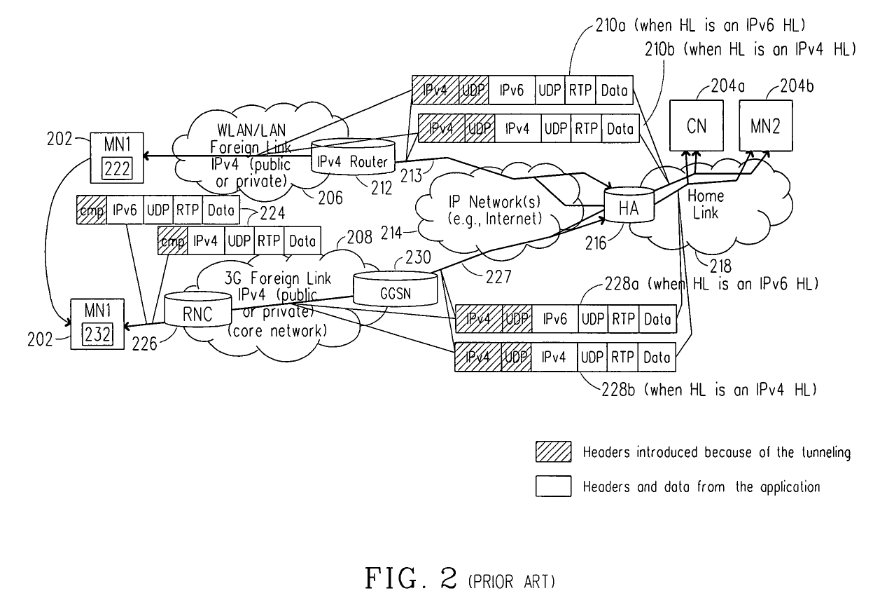

From the foregoing, it can be readily appreciated by those skilled in the art that the present invention described herein reduces the overhead of the tunneled traffic between a MN and a remote device (e.g., HA, CN, MN) by using an IP header compression algorithm between them such as Robust Header Compression (ROHC) [see, RFC 3095]. In the prior art, ROHC is normally used between the MN and some node (RNC) in a radio access network (RNC). However, the tunneled packet is carried through rest of the access network and the IP Network(s) (e.g., Internet) in uncompressed format (see FIGS. 1 and 2). To address this problem, the present invention uses separate compression contexts where one compression context is used between the MN and the RNC (for instance) and the other compression context is used between the MN and the remote device (e.g., HA, CN, MN). In this way, one can reduce the overhead of these tunneled packets while they are routed through the access network and the Internet.

The overhead can also be reduced in situations where the IP header compression would not normally be used at all such as in a WLAN/LAN access network. In this case, the header compression context between the MN and remote device (e.g., HA, CN, MN) can be used to compress the inner IP header of each tunneled packet. The outer IP header (IPv4/UDP or IPv6) cannot be compressed as it is needed to route the packets through the IP Network(s) (e.g., Internet). However, as described above, the outer IP header can still be compressed separately by the MN and the wireless access network. It should be noted that the IP header compression between the MN and the remote device (e.g., HA, CN, MN) does not decrease the compression ratio over the aerial link.

Following are some additional features and advantages associated with the present invention:
The bandwidth consumption of the MN in the access networks and Internet is reduced.
The IP header compression algorithm reduces the errors caused by the network located between the compression context peers.
The business value of possible Mobile IPv6 implementations within MN which can be used in different address space environments is enhanced.
The business value of the HA is increased if it is capable to perform IP Header Compression with MN's in accordance with the present invention.
The present invention can also be used if a MN is connected to an intranet, extranet and even an intranet/extranet connected to the Internet.
The IP headers can be compressed by the present invention by utilizing anyone of the following compression algorithms (for example):
   (1) ROHC: Bormann et al. “RObust Header Compression (ROHC): Framework and Four Profiles: RTP, UDP, ESP, and Uncompressed”, RFC 3095, July 2001.
   (2) CTCP: V. Jacobson “Compressing TCP/IP headers for Low-Speed Serial Links”, RFC 1144, February 1990.
   (3) IPHC: M. Degermark et al. “IP Header Compression”, RFC 2507, February 1999.
   (4) CRTP: S. Casner et al. “Compressing IP/UDP/RTP Headers for Low-Speed Serial Links”, RFC 2508, February 1999.
The contents of these documents are incorporated by reference herein.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

What is claimed is:

1. A mobile node, that is connected to a wireless communications network, that compresses a packet such that the compressed packet which includes an outer IP header, a compressed inner IP header and data can be sent within a bi-directional tunnel via at least one IP network to a remote device.

2. The mobile node of claim 1, wherein said outer IP header is compressed when said compressed packet is going to be sent within an aerial interface in addition to being sent within the bi-directional tunnel via the at least one IP network to the remote device.

3. The mobile node of claim 1, wherein:
said outer IP header is an IPv6 header or is including an IPv4 header and a UDP header; and
said compressed inner IP header is formed from an IPv4 header, an UDP header and a RTP header or an IPv6 header, an UDP header and a RTP header.

4. The mobile node of claim 1, wherein said remote device is a home agent, a correspondent node or another mobile node.

5. The mobile node of claim 1, wherein said packet is compressed by one of the following:
a ROHC compression algorithm;
a CTCP compression algorithm;
an IPHC compression algorithm; or
a CRTP compression algorithm.

6. A method in a telecommunications network for compressing a packet, said method comprising the steps of:
checking a routing table and learning that a packet is going to be sent within a bi-directional tunnel via at least one IP network to a remote device;
compressing an IP header in said packet;
forwarding said compressed packet to a tunnel interface;
adding an outer IP header to said compressed packet; and
sending said compressed packet to said remote device.

7. The method of claim 6, further comprising the step of:
compressing said outer IP header when said compressed packet is going to be sent within an aerial interface in addition to being sent within the bi-directional tunnel via the at least one IP network to the remote device.

8. The method of claim 6, wherein:
said outer IP header is an IPv6 header or an IPv4 header and a UDP header; and
said compressed IP header is formed from an IPv4 header, an UDP header and a RTP header or an IPv6 header, an UDP header and a RTP header.

9. The method of claim 6, wherein said remote device is a home agent, a correspondent node or a mobile node.

10. The method of claim 9, wherein said home agent further decompresses the received compressed packet.

11. The method of claim 9, wherein said correspondent node further decompresses the received compressed packet when traffic between said mobile node and said correspondent node is route optimized.

12. The method of claim 6, wherein said packet is compressed by one of the following:
a ROHC compression algorithm;
a CTCP compression algorithm;
an IPHC compression algorithm; or
a CRTP compression algorithm.

13. A home agent that compresses a packet such that the compressed packet which includes an outer IP header, a compressed inner IP header and data can be sent within a bi-directional tunnel via at least one IP network to a remote device.

14. The home agent of claim 13, wherein said outer IP header is compressed when said compressed packet is going to be sent within an aerial interface before being sent within the bi-directional tunnel via the at least one IP network to the remote device.
